(19) United States
(12) Patent Application Publication
(10) Pub. No.: US 2013/0103451 A1
(43) Pub. Date: Apr. 25, 2013

(54) SYSTEM AND METHOD FOR GATHERING, ANALYZING, MANAGING AND SHARING GROUND MODIFICATION OPERATION DATA

(71) Applicant: Advanced Construction Techniques Ltd., Kettleby (CA)

(72) Inventors: James Cockburn, King (CA); Douglas Heenan, Toronto (CA)

(73) Assignee: ADVANCED CONSTRUCTION TECHNIQUES LTD., Kettleby, Ontario (CA)

(21) Appl. No.: 13/656,141

(22) Filed: Oct. 19, 2012

(30) Foreign Application Priority Data
Oct. 19, 2011 (CA) 2755534

(51) Int. Cl. G06Q 10/06; G06F 19/00

(52) U.S. Cl. 705/7.23; 702/2

(57) ABSTRACT

A system and method for gathering, analyzing, managing and sharing data from a ground modification project is disclosed. The system includes a process, a data producer interface, a storage device and a data consumer interface. The data producer interface interfaces with one or more data producers, which are located on-site of the ground modification project and produce data associated with the ground modification project. The storage device stores the data produced by the one or more data producers and received using the data producer interface. The data consumer interface interfaces with one or more data consumers, the data consumer interface providing access to the data stored in the storage device.

### TECHNICAL FIELD

The present disclosure relates to ground modification and, in particular, to a system and method for gathering, analyzing, managing and sharing ground modification operation data.

### BACKGROUND

Ground modification broadly refers to the modification of some properties of the ground, such as soil, for a particular use. For example, ground modification techniques may be used to create barriers to arrest surface and subsurface water flow; to displace or densify soil; to stabilize rock formations; to re-level building and structures; to form landfill barriers; to create grouting curtains along foundations; to construct slip liners; to construct slurry walls; and to reconstruct or abandon tunnel and service conduits.

In performing these ground modification techniques, one or more pieces of field equipment may be used. For example, in constructing slurry walls, a hydromill trench cutter may be used to excavate trench sections deep into the ground according to specification, which would then be filled with slurry. Many modern field equipment employed in ground modification operations are data-enabled and transmit telemetry in real-time. For example, a drill may transmit the x, y and z positions of the drill bit. Because field equipment produce data relating to ground modification operations, they will be hereinafter collectively referred to as “data producers”.

Typically, a ground modification project may require several different ground modification operations. For example, making the foundation for a skyscraper may require hydromilling, drilling and concrete pouring. The data associated with each operation is collected and stored separately. Some data that are not measured by field equipment may also be written down on a piece of paper. Thus, current systems and methods of managing and gathering ground modification data are inadequate and inefficient. Moreover, current systems do not provide a mechanism for sharing ground modification operation data between different ground modification operations and projects.

Therefore, there is a need for a system and method for gathering, analyzing, managing and sharing ground modification operation data efficiently.

### SUMMARY

According to an aspect of the invention, a system for gathering, analyzing, managing and sharing data from a ground modification project is disclosed. The system includes: a processor; a data producer interface coupled to the processor, the data producer interface for interfacing with one or more data producers, the one or more data producers being located on-site of the ground modification project and producing data associated with the ground modification project; a storage device coupled to the processor, the storage device for storing the data produced by the one or more data producers and received using the data producer interface; and a data consumer interface coupled to the processor, the data consumer interface for interfacing with one or more data consumers, the data consumer interface providing access to the data stored in the storage device.

According to another aspect of the invention, a method for gathering, analyzing, managing and sharing data from a ground modification project is disclosed. The method executed by a processor includes: creating a project plan for the ground modification project, the project plan including one or more resources available for the ground modification project; managing the one or more resources available for the ground modification project; receiving data from one or more data producers, the one or more data producers being located on-site of the ground modification project; storing the received data in a storage device; verifying the received data against a criterion; and making available to one or more data consumers received data that satisfies the criterion.

In accordance with another aspect of the present disclosure there is provided a computer readable storage medium storing instructions or statements for use in the execution in a processor of a method for gathering, analyzing, managing and sharing data from a ground modification project as described above.

In some embodiment, the method repeats by continuing to receive data from the one or more data producers.

In some embodiment, the method further comprises converting the received data to an engineering value, and storing the engineering value in the storage device.

In some embodiment, storing the received data in a storage device may further comprise storing the received data in a historian database.

In some embodiment, storing the received data in a storage device may further comprise storing the received data in an engineering database.

In some embodiment, storing the received data in an engineering data base may comprise categorizing the received data, and storing the categorized data in a table of the engineering database.

In some embodiment, the criterion may comprise an empirical model or a rule or both.

In some embodiment, verifying the received data against the empirical model comprises calculating a result of the empirical model using the received data, and determining whether the result meets a threshold.

In some embodiment, verifying the received data against the rule comprises applying the rule against the received data, and determining whether the received data conforms to the rule.

In some embodiment, verifying the received data against the empirical model or rule further comprises generating a message if the result does not meet the threshold or the received data does not conform to the rule.

In some embodiment, either or both of the empirical model and the rule may be configurable in the project plan.

In some embodiment, managing the one or more resources comprises assigning the one or more resources available to an operation of the ground modification project.

In some embodiment, creating a project plan for the ground modification project further comprises verifying the created project plan for an inconsistency, inefficiency or anomaly, or a combination thereof.

In some embodiment, the one or more data producers comprise a data-enabled field equipment or a manual-logging device or both.

In some embodiment, the data-enabled field equipment comprises a clamshell excavator, a hydromill, a calipering device, a drilling monitor, a Rotary Steerable System drill, a pressure testing cart, a grouting cart, an optical televiewer, a circular element drill, a core drill, a directional drill, a percussive drill, a pile drill, a survey instrument, a borehole surveyor, a borehole imager, a batch mixing plant, a water plant, or a geotechnical instrument, or any combination thereof.

In some embodiment, the one or more data consumers comprise a monitoring module, a design and drawing module, a reporting module, an accounting module, a quality control module, a verification module, a messaging module, a configuration module or a scheduling module, or any combination thereof.

In some embodiment, the storage device further includes a historian database.

In some embodiment, the storage device further includes an engineering database.

In some embodiment, the storage device further includes an accounting database.

In some embodiment, the data producer interface interfaces with the one or more data producers using a wireless technology.

### BRIEF DESCRIPTION OF THE DRAWINGS

Further features and advantages of the present disclosure will become apparent from the following detailed description, taken in combination with the appended drawings, in which:

FIG. 1 illustrates a block diagram of a system according to an embodiment of the present technology;

FIG. 2 illustrates the system as shown in FIG. 1 and various components interfacing with the system;

FIG. 3 illustrates a process for gathering, analyzing, managing and sharing ground modification operation data;

FIG. 4 illustrates a project resource planning module, which is an exemplary embodiment of a scheduling module;

FIG. 5 illustrates a task manager module, which is an exemplary embodiment of a monitoring module;

FIG. 6 illustrates examples of data producers interfacing with the data producer interface;

FIG. 7 illustrates an interface for inputting drilling information, which may be implemented on a manual-logging device;

FIG. 8 illustrates a message centre module, which is an exemplary embodiment of a messaging module;

FIG. 9 illustrates examples of data consumers interfacing with the data consumer interface;

FIG. 10 illustrates an exemplary implementation of the monitoring module for monitoring concrete placement;

FIG. 11 illustrates an exemplary implementation of the monitoring module for monitoring hydromill operation; and

FIG. 12 illustrates a module for surveying boreholes, which is an exemplary embodiment of a quality control module.

FIG. 13 is an exemplary embodiment of a 3D user interface.

It will be noted that throughout the appended drawings, like features are identified by like reference numerals.

### DETAILED DESCRIPTION

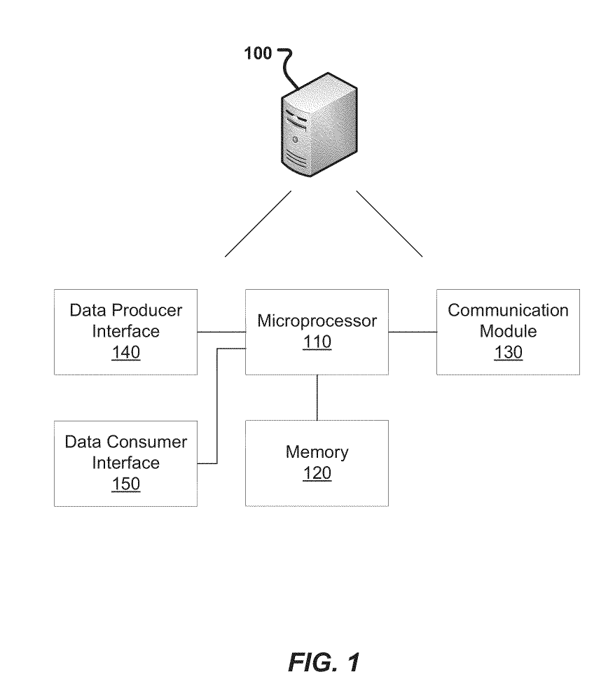

Embodiments are described below, by way of example only, with reference to FIGS. 1-13.

The present disclosure describes a system and method for gathering, analyzing, managing and sharing ground modification operation data from a ground modification project. Typically, a ground modification project involves many different types of operations that require the use of various unrelated and dissimilar field equipment. The present technology provides a system and method for collecting information from all the different field equipment, including observed values by on-site personnel, and managing and sharing such information. Thus, the present technology acts as a central hub for the information pertinent to the one or more ground modification operations needed in a ground modification project. Furthermore, since the ground modification project may take place in a remote location, the present technology may be implemented as a mobile solution that can be transported to or near the site of the ground modification project and set up for the project.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

### Overview

Referring to FIG. 1, a schematic depiction of a system 100 for implementing an embodiment of the present technology is shown. It should be expressly understood that this figure is intentionally simplified to show only certain main components. The system 100 may include other components beyond what is illustrated in FIG. 1. In the present disclosure, the system 100 may also be referred to as an IntelliSystem™ control centre.

As illustrated in FIG. 1, the system 100 includes a microprocessor 110 (or simply a “processor”) that interacts with memory 120. The memory 120 may be in such forms as random access memory (RAM), flash memory, hard disk drives, solid state drives, or any other forms contemplated by a person skilled in the art. The system 100 further includes a communication module 130 for enabling communication. For example, the data producer interface 140 may use the communication module 130 to receive telemetry from data-enabled field equipment (i.e. data producers as it will be described below). The communication module 130 may use wired or wireless technologies including, but not limited to: IEEE 802.11x standards (sometimes referred to as Wi-Fi) such as, for example, the IEEE 802.11a, 802.11b, 802.11g, and/or 802.11n standard; IEEE 802.15.4-2003 (also referred to as Zigbee); IEEE 802.16e (also referred to as Worldwide Interoperability for Microwave Access or “WiMAX”); IEEE 802.20 (also referred to as Mobile Wireless Broadband Access); IEEE 802.3 (Ethernet) standard; and any other communication standards reasonably contemplated by a person skilled in the art. The communication module 130 may also be designed to operate with various cellular technologies including, but not limited to: Mobitex Radio Network, DataTAC, FHSS (Frequency Hopping Spread Spectrum), GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA1010, EDGE (Enhanced Data rates for GSM Evolution), UMTS (Universal Mobile Telecommunication Systems), HSDPA (High-Speed Downlink Packet Access), IEEE 802.16e (also referred to as Worldwide Interoperability for Microwave Access or “WiMAX”), or various other network technologies.

The system 100 further includes a data producer interface 140 for interfacing with one or more data producers. As described above, data producers generally refer to field equipment used in ground modification operations. Such field equipment may include, but not limited to, a core drill, direction drill, percussive drill, hydromill, pile drill, excavation survey instruments, borehole surveyor/imager, batch mixing plant, pressure testing cart, grouting cart, building/utility/ground movement instrumentation, geotechnical instrumentation, and others. As it will be described below, in addition to field equipment, the system 100 may also interface with (through the data producer interface 140) a remote computer that field personnel may use to manually log information observed or measured at the site of the ground modification project. Such remote computer may also be referred to as a manual-logging device or an IntelliLog™ device.

The data received using the data producer interface 140 is made available to one or more data consumers through the data consumer interface 150. In the present disclosure, the term data consumer refers to internal or external modules to the system 100 that uses the data received using the data producer interface 140. Exemplary implementations of data consumers of system 100 will be further described below.

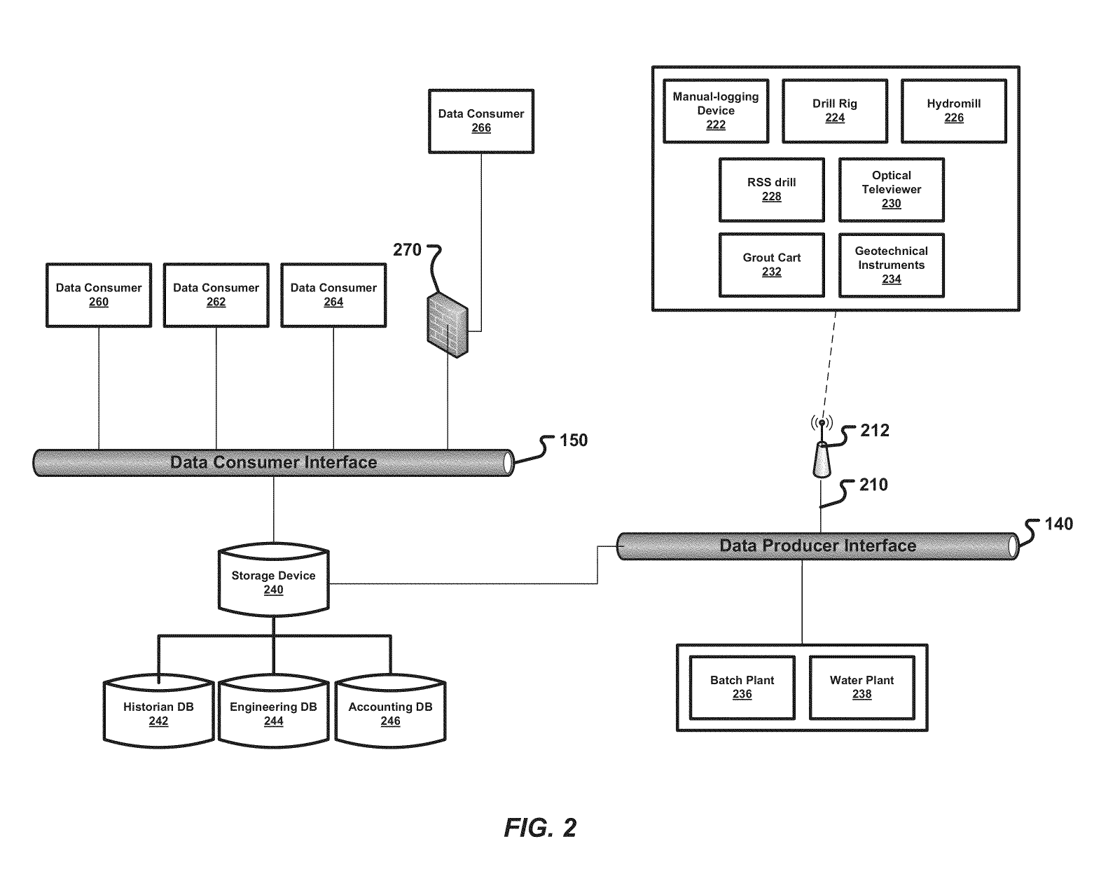

Now turning to FIG. 2, an exemplary implementation of the system 100 and its various components are shown. It is to be understood that FIG. 2 is a simplified overview of the different components of the system 100 and that the system 100 is not limited to the components as depicted in FIG. 2.

The system 100 uses the communication module 130 and the data producer interface 140 to communicate with one or more data producers. As shown in FIG. 2, the system 100 uses wired 210 or wireless 212 technologies to interact with the one or more data producers. In FIG. 2, several data producers are shown, including a manual-logging device 222, drill rig 224, hydromill 226, RSS (Rotary Steerable System) drill 228, optical televiewer (also referred to as an IntelliCAM™ device) 230, grout cart 232, geotechnial instrument 234, batch plant 236 and water plant 238.

The data received from the data producers are then stored in a storage device 240. In this particular embodiment, received data is stored in an arrangement of historian database 242, engineering database 244 and accounting database 246. As data is received from the one or more data producers, the data is stored in the historian database 242. The data may then be converted to an engineering value, verified, and then stored in the engineering database 244. The engineering value refers to a value that has a meaning in the field of ground modification. Since the telemetry received from the field equipment may be in raw form, such as an analog value, the system 100 may convert the received data to an engineering value. However, where the telemetry is already in a useful form (such as a value logged by a site personnel using the manual-logging device 222), conversion may not be necessary. Furthermore, the engineering database may be arranged to classify the received data into different categories to increase efficiency. The classification may be arranged in such a way to increase efficiency. For example, the system 100 may categorize the received data based on the nature of the data such as hydromilling, grouting or cement placement operations. Alternatively, or additionally, the system 100 may classify the received data based on the source of the data, such as classifying data as originating from the drill rig 224, the hydromill 226 or cement trucks. Thereafter, the system 100 may store the classified data in separate tables in the engineering database.

The storage database may further include an accounting database 246 to maintain the work performed by the system 100, which may be used for accounting purposes. The storage device 240 may be implemented on a single storage medium local to the system 100 or may be implemented on a multiple storage medium distributed across a network. Other storage configurations may be contemplated by the person skilled in the art.

The information stored in the storage device 240 are then accessed by one or more data consumers using the data consumer interface 150. While FIG. 2 depicts data consumers 260, 262, 264 and 266, it will be understood by the person skilled in the art that there may be more or less data consumers 260, 262, 264 and 266 than shown in FIG. 2. Where the data consumer, such as data consumer 266, is located remotely, access to the data consumer interface 150 may be limited to authorized data consumers by the presence of a firewall 270.

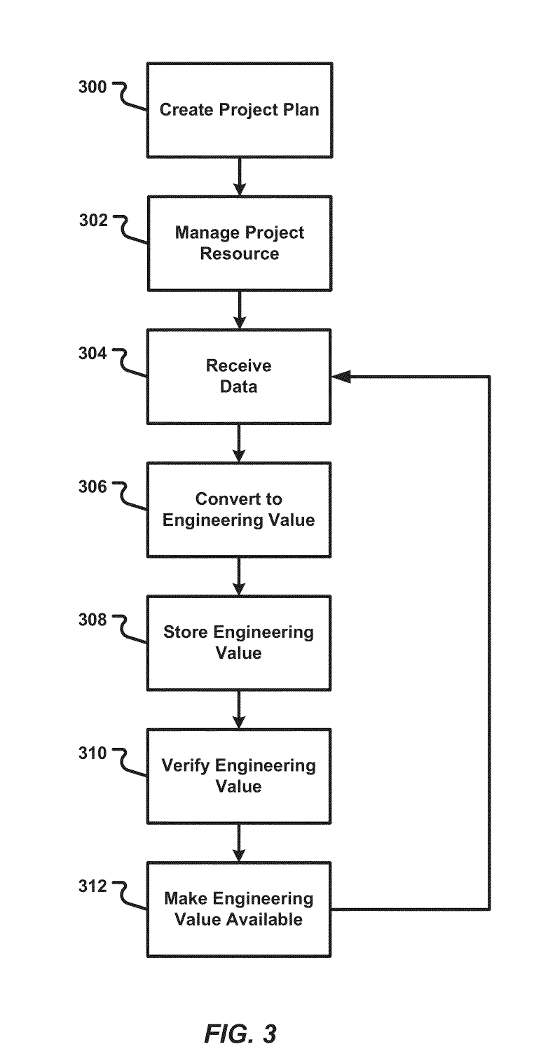

Thus, system 100 facilitates the gathering, analyzing, managing and sharing of ground modification operation data. As shown in FIG. 3, at 300, a ground modification project plan is created. This may involve configuring the system 100 for a particular ground modification project since the system 100 may be used for multiple ground modification projects.

At 302, the available resources for the ground modification project are managed. In this disclosure, the term resource refers to any data producers (i.e. field equipment and manual-logging device), personnel, operators and other things available for the performance of the ground modification project. For example, while a ground modification project may comprise of drilling ten different bore holes, there may be only three drilling rigs available at the site. The system 100 allows planning to ensure that available resources are efficiently used.

At 304, the system 100 begins to receive data from the one or more data producers. The data producer may be a data-enabled field equipment or a mobile computing device for manually logging field-related information through a manual-logging device.

At 306, the received data may be converted to an engineering value. For example, the data-enabled field equipment may generate an analog value, such as a voltage measurement, that may not readily have a meaning in the field of ground modification. Using a method defined in the project plan (e.g. a conversion constant in the operational parameter), the received data may be converted to an engineering value. For example, a pressure transducer may measure pressure and generate a signal between 4 and 20 mA. The pressure transducer may only measure between 0 and 50 psi. Thus, for this particular pressure transducer, the relationship between the generated signal and pressure may be expressed as pressure=3.125*(mA signal)−12.5. Using this relationship, if the received data is 12.2 mA, the converted engineering value would be 25.625 psi. However, conversion to an engineering value may not be necessary in other circumstances. For example, a data manually logged by an on-site personnel may not need to be converted. Both types of values, whether converted or not, will hereinafter referred to as an engineering value.

At 308, the converted engineering value is stored in the storage device. In one embodiment, the data received from the one or more data producers may be stored in a separate historian database as discussed above, while the converted engineering value may be stored in an engineering database. This allows the system 100 to distribute data processing tasks while increasing efficiency. The stored data may also be compressed.

At 310, the converted engineering value is verified. In one implementation, verification may entail running the engineering value through an empirical model with configurable parameters. While running the engineering value through the empirical model, the system 100 may verify the results to detect any anomalies. In a further implementation, verification may entail applying one or more rules to the engineering value. The details of engineering value verification will be further discussed below.

At 312, the verified engineering value is made available to one or more data consumers. The system 100 then returns to block 304 to receive new data from the one or more data producers.

### Project Creation

The system 100 may be used for many different ground modification projects. For example, the system 100 may have been used to create a deep foundation for a new skyscraper. This may have required managing hundreds of concrete pouring operations. After the project, the system 100, which may be embodied in a mobile container, may be transported to a remote site for an exploratory drilling project. Upon arrival at the remote site, the system 100 may create a new project plan appropriate for the drilling project.

Thus, before any telemetry is received by the system 100, a project plan is created to configure the system 100 for the specific ground modification project. This may involve defining parameters, creating necessary databases and setting up configurations for the project. Some parameters and configurations include, but are not limited to:

TABLE 1
Exemplary parameters and configurations

| Parameter/ | |
|---|---|
| Configuration | Description |
| Operational | Defines aspects of the ground modification operation |
| Parameter | to be monitored by system 100. Parameters may |
| | include: |
| | Point value limits for variable monitoring |
| | Operational constraints, such as the allowable |
| | depth of a tremie pipe, for process management |
| | Constants for converting raw values into |
| | engineering values |
| Site Parameter | Defines the characteristics of the site, as it varies with |
| | different job sites. Parameters may include geological |
| | formation definition, geological formation porosity and |
| | water table elevation. |
| Holes, | Defines holes, excavation elements and survey points |
| Excavation | that may be worked on or monitored during a ground |
| Elements, | modification project. Information about the objects |
| Survey Point | may include physical location and dimensions in x, y |
| Definitions | and/or z plane. |
| IntelliCADD ™ | Configuration for the module that provides engineering |
| module | drawings. |
| Configuration | |
| Rules | Rules that are used to verify the engineering values. It |
| Configuration | may also be used for scheduling project resources. |
| Security | Defines the rights to the system 100 for each operator |
| Configuration | of the system 100. |
| Equipment | Defines information about the one or more data |
| Configuration | producers. |
| Comments | To standardize information input into the |
| Configuration | IntelliSystem ™ control centre by all users, a menu of |
| | comments is made available within all modules |
| | depending on the situation. These comments are |
| | configured at the beginning of a ground modification |
| | project by management personnel. |
| Contract Set-up | Defines information related to the ground modification |
| | project contract. This information is used for |
| | accounting purposes. |

In this disclosure, the module for creating and configuring the project parameters may also be referred to as IntelliConsole™ module. As it will be described below, the project parameters may also be verified by a verification module.

### Project Planning

With the project plan set up and configured for the specific ground modification project, the available project resources may be managed. In this disclosure, the module for managing project resources may be referred to as the IntelliPlan™ module and IntelliMonitor™ module.

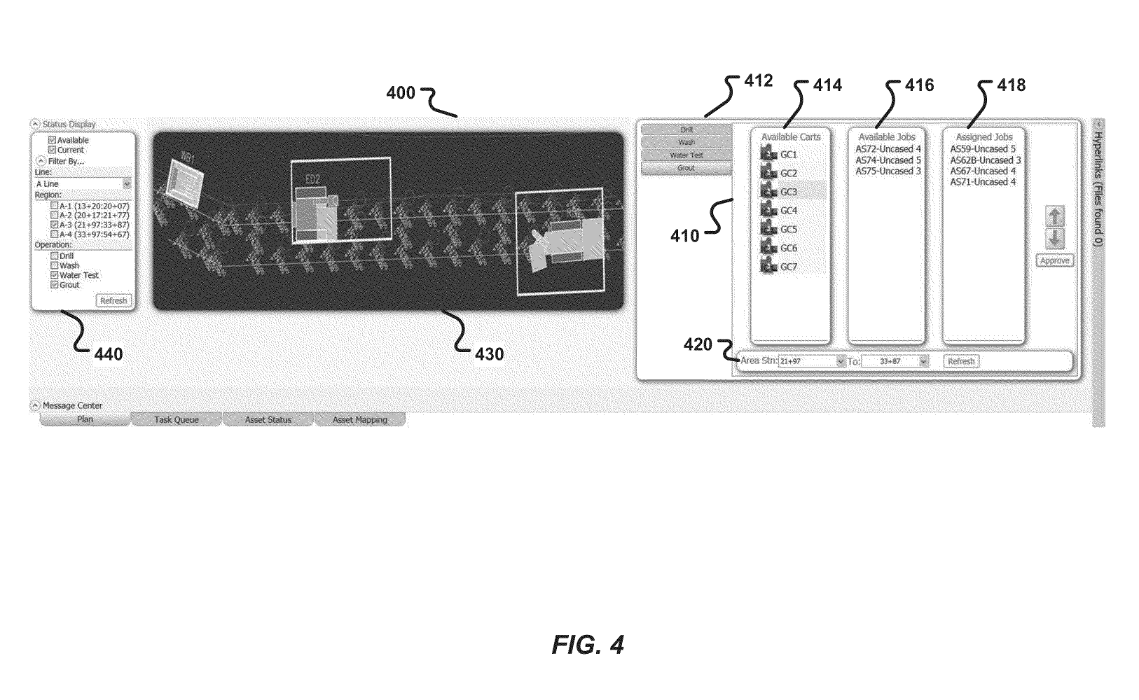

Referring to FIG. 4, an exemplary embodiment of a project resource planning module 400 is shown. Using this module, the user of the system 100 is able to effectively plan the available resources at the ground modification project site. For example, using the operations list 412 in the resource window 410, the operator may select to manage the grouting operation. In FIG. 4, grout operation is selected. Upon selection, the operator is presented with the available resources (e.g. available grouting carts 414), available unassigned operations (e.g. available grouting jobs 416) and operations assigned to a resource (e.g. assigned grouting jobs 418). The information presented to the operator in 414, 416 and 418 may be defined by an area station window 420, which defines the area of interest when retrieving information for presentation to the operator. Furthermore, a graphical representation of the ground modification project may be shown in a project window 430. By using the resource window 410 and the project window 430, the resources available at a ground modification project site may be effectively managed.

The project resource planning module 400 may include further functionalities. For example, a filter window 440 may be included to allow the operator to control the amount of information displayed in the project resource planning module 400.

The project resource planning module 400 may also include modules for recommendations, predictions and simulations (not shown). For example, the recommendation module may suggest an efficient resource assignments to the available jobs. The recommendation module may also make recommendations, based on historical data, status of available field equipment, site personnel, and site operations to suggest “the next step” in the resource planning. Based on the recommendation, the system operator may accept the recommendation, make adjustments to the recommendation or ignore the recommendation.

As for the prediction module, an exemplary feature may include projecting completion times of scheduled jobs based on the resource planning, along with the projected efficiency of the project based on the plan.

As for the simulation module, it may allow the operator to simulate different scenarios based on the available resources and jobs. For example, if a failure occurs for a piece of scheduled equipment, the simulation module may simulate the decrease in project efficiency. Or, simulate the change in completion time.

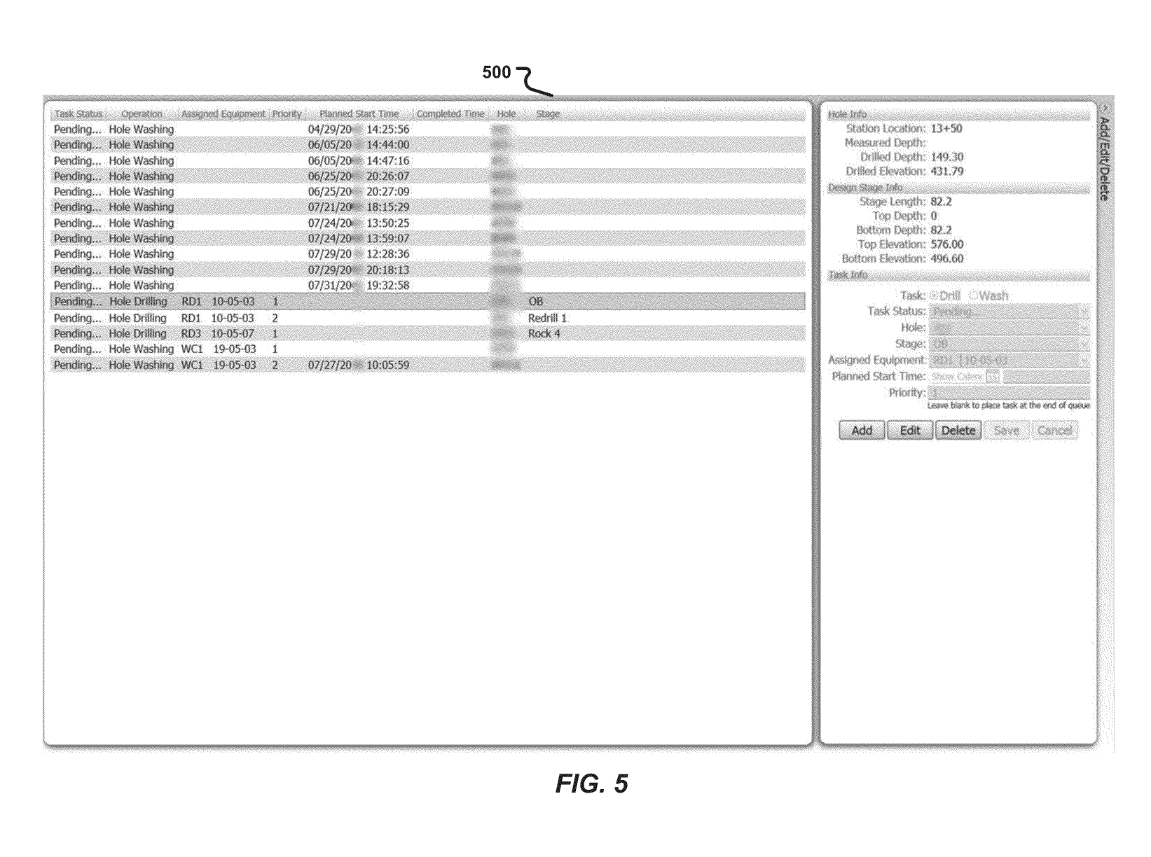

With the project resources assigned and managed, the operator of the system 100 may monitor the progress and status of job in a task manager module 500, an example which is shown in FIG. 5. Using this module, the operator of the system 100 is able to monitor the progress of the ground modification operation and the assigned resources to ensure safe and timely completion of the operation. As shown in FIG. 5, there is a wealth of information that may be available for consumption. In addition, the task manager module 500 may also be used to change the priority of the tasks when necessary. The task manager module 500 may be part of IntelliMonitor™ as it will be further described below.

### Data Collection Through Data Producers

Data collection begins once the ground modification project is created and the resources are assigned. This is enabled through the data producer interface 140 as discussed above. In the present disclosure, data producers may be a data-enabled field equipment or a manual-logging device.

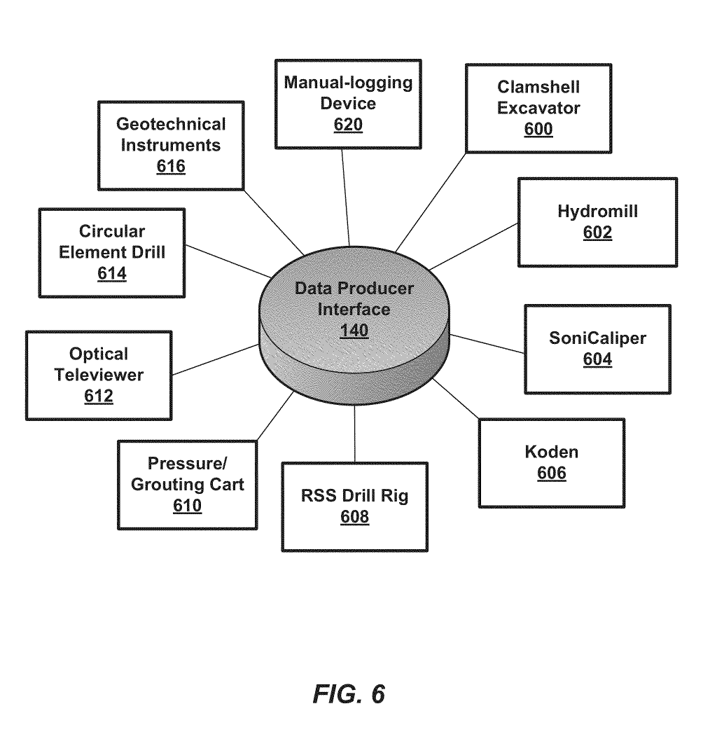

Referring to FIG. 6, examples of data producers interfacing with the data producer interface 140 are shown. Some examples of data-enabled field equipment include: clamshell excavator 600, hydromill 602, a calipering device (such as SoniCaliper™) 604, a drilling monitor (such as Koden™) 606, RSS drill rig 608, pressure/grouting cart 610, optical televiewer 612, circular element drill 614, and geotechnical instruments 616 such as piezometers, inclinometers, extensometers, in-hole velocity meters, water level gauges and pool levels. In addition, the data may be provided to the system 100 using a manual-logging device 620. The manual-logging device 620 may also be used to receive operational data or directives from the system 100. These data producers may interface with the data producer interface 140 wirelessly or through a wired connection as previously discussed above.

An exemplary use of the one or more data producers will now be described. Consider a ground modification project that requires several operations. For example, the ground may need to be excavated using an RSS drill rig 608, a hydromill 602 and other drills such as circular drill 614. Moreover, grouting curtains may need to be created using grouting cart 610. Further, a part of the excavated ground may need to be filled with concrete using cement trucks. Finally, the site personnel may conduct some verification using an optical televiewer 612 and other quality checks.

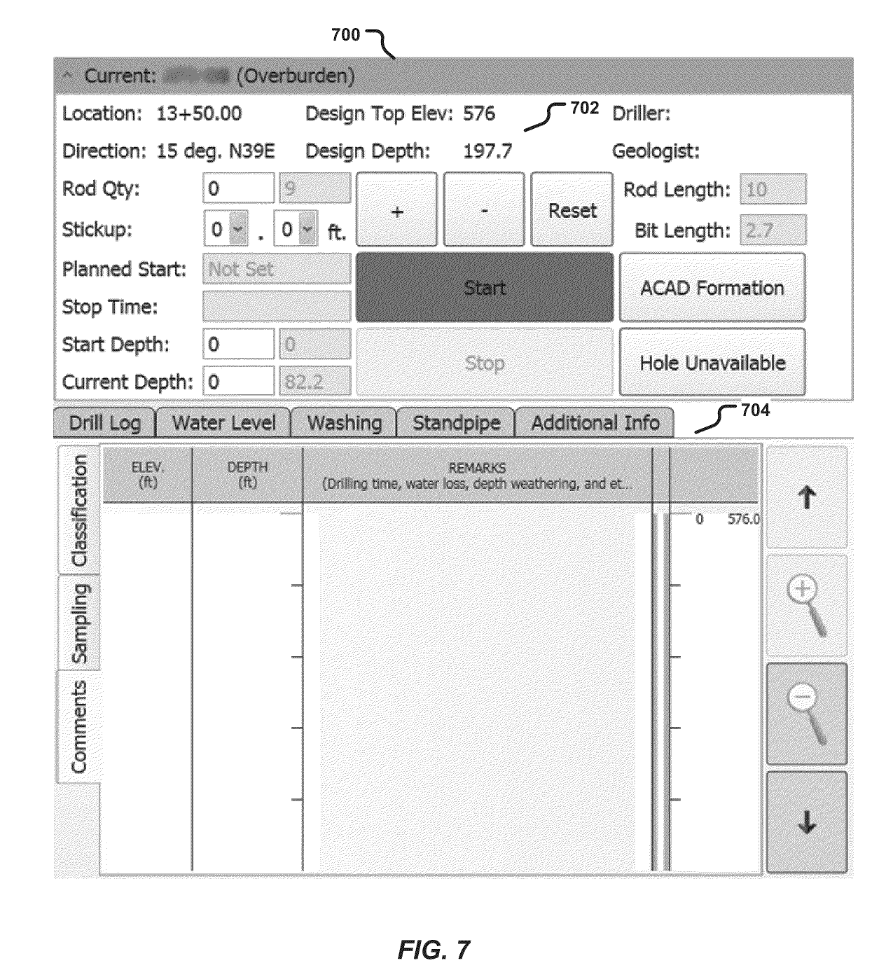

First, in the ground excavation operation, field equipment may create many rectangular or circular cavities in the soil and rocks at various depths. These cavities will be hereinafter referred to as elements. During such excavation, the system 100 may treat each rectangular element or circular element as an anchor for information, which allows the system 100 to access and manage the data efficiently. During the excavation, one or more data producers may generate data. Using the system 100, the data generated from the one or more data producers are received at the system 100. In other words, the system 100 acts as the central information hub for the information generated by the one or more data producers. For example, the hydromill 602 may generate the following information: cutting depth, cutter inclination, cutter deviation, cutter rotation, cutting rate, slurry inlet flow rate, slurry outlet flow rate, inlet slurry density, outlet slurry density and slurry level. The RSS drill rig 608 may generate the following information: x, y and z position of the drill bit, azimuth, inclination, rate of penetration, local gravity, local magnetic field strength, and local magnetic dip angle. The circular drill 614 may generate the following information: depth, MWD (Monitor While Drilling) data, drill rotation, torque and down pressure. Moreover, on-site personnel may use the manual-logging device 620 to record further data such as: description of equipment, station, start and stop depths/elevation, start and stop times, excavation depths and elevation, type of cutter used, description of material excavated, comments, observed water levels, soft zones and problems encountered. An exemplary interface 700 for inputting drilling information using the manual-logging device 620 is shown in FIG. 7. As shown in FIG. 7, the interface 700 on the manual-logging device 620 not only conveys information about the ground modification operation (e.g. hole information 702) but also has a section 704 for conveying information to the system 100. The interface 700 may further include a panel (e.g. message centre module 800) for displaying directives from the system 100.

The project may further require grouting by using a grouting cart 610. The grouting cart 610 may produce telemetry such as gauge pressure and flow rate during grouting operations. Additional observations and comments may also be inputted into the manual-logging device 620. Furthermore, certain grouting operations are done under a building or utility infrastructure, and thus, monitoring of the movement of such building or utility infrastructure may be required. Site operators may install surveying equipment at specific survey points, which the system 100 may communicate with to receive telemetry such as current x, y and z position.

Where the excavated site requires concrete placement, the system 100 not only provides management of the one or more cement trucks, but it may be able to receive information relating to each concrete block inputted by a site personnel using the manual-logging device 620. For example, an ID may be assigned to each concrete block and information such as water addition time stamp, volume and weight of the cement, and mix type may be inputted. Other information related to the quality of the cement may also be inputted.

Upon the completion of the operation, a survey of the completed job may be done. For example, this may be performed visually by on-site personnel and observations may be inputted using the manual-logging device 620. Additionally, or alternatively, site personnel may use the optical televiewer device 612 to capture, for example, borehole images and videos. Moreover, optical televiewer device 612 may also transmit x, y and z coordinates at specified depth/elevation intervals to the data producer interface 140, which may be used to determine deviation data.

An exemplary embodiment of the manual logging device 620 is shown in the attached Appendix entitled “IntelliLog Remote User Manual” which is expressly incorporated herein by reference. In prior systems, geological information gathered during drilling operations was handwritten into a geologist's log. This information was then taken by the geologist and entered into a specialized application. The information was not incorporated into a database. The IntelliLog manual logging device 620 provides a wireless mobile solution that allows personnel in the field to manually enter information. This data is transmitted and stored into the databases discussed above. Not only is the geologist's geological information captured by the device 620, drilling, hydromill, wash, concrete placement and quality control information is also captured with the logging device 620. The following benefits are realized by using the IntelliLog device:

1. All input is standardized. There are no longer varying levels descriptiveness in the information captured in the field.

2. Information is received in real time. This allows operators to make decisions based on an up to date operational picture.

3. Data quality is greatly improved.

Thus, the system 100 receives data from one or more data producers that may relate to different ground modification operations. The system 100 serves as the central information hub for many different data producers and may facilitate sharing of information between the different ground modification operations.

### Processing Collected Data

With the data received from the one or more data producers, processing may be done prior to making the data available to one or more data consumers. Processing may comprise of one or more actions.

First, where necessary, the received data may be converted to an engineering value. As previously described, the system 100 may receive data from the one or more data producers in raw form, such as an analog value. In such a case, the system 100 may convert the received data to an engineering value that has a meaning in the field of ground modification. However, in other cases, conversion may not be necessary (e.g. a site-observed value inputted by a site personnel using the manual-logging device). Both types of values, whether converted or not, will be hereinafter referred to as an engineering value. The engineering value is then stored in a storage device, such as storage device 240.

Second, the stored engineering value may be verified using one or more criteria. Verification may be based on empirical models that have been configured for the specific ground modification project. Additionally, or alternatively, verification may be based on rules defined by the operator of system 100. Both rule definition and empirical model configuration may have been done during the project creation, such as block 300 in FIG. 3.

TABLE 2
Exemplary verification

| Exemplary | |
|---|---|
| Verification | Description |
| Hydromill and | Deviation information is used to determine if it violates |
| Directional | defined constraints. |
| Drill Deviation | |
| Slurry Level | During hydromill and pile drill excavation operations, |
| | information regarding slurry level, inlet/outlet rates for |
| | the slurry and the specific gravity of the inlet/outlet |
| | streams may be monitored. Information such as risk of |
| | slurry loss may be detected and notified. |
| Cement Truck | The cement trucks and the age of the cement batches |
| Management | contained therein are tracked. |
| Concrete | The placement of concrete in the excavated site is |
| Placement | tracked. The verification module may observe: |
| | theoretical concrete level vs. actual concrete level; |
| | difference between level readings in distinct locations |
| | within the excavation; and depth of tremie pipe within |
| | the concrete. |
| Structure/ | With the x, y and z position of the surveying equipment, |
| Ground | the verification module is able to determine any |
| Movement | movement. Movement outside of a defined limit may be |
| | detected and notified. |
| Refusal | The verification module may track the total grout |
| | volume and flow rate to determine if the borehole |
| | section is refusing to take more grout. |
| SOPS | Using defined rules, the verification module determines |
| (Standard | if a project process is adhering to standard operating |
| Operating | procedures. The verification module may further |
| ProcedureS) | sequester the data for a specified time during which an |
| | operator of the system 100 would be required to review |
| | and approve/reject the data. Upon verification, alerts or |
| | suggested courses of action may be generated. |
| Scheduling | Depending on the information such as status of field |
| | equipment, amount of work to be completed and current |
| | planned resources, the verification module may verify |
| | the current schedule of the resources. Based on |
| | verification, a new schedule may be proposed. |

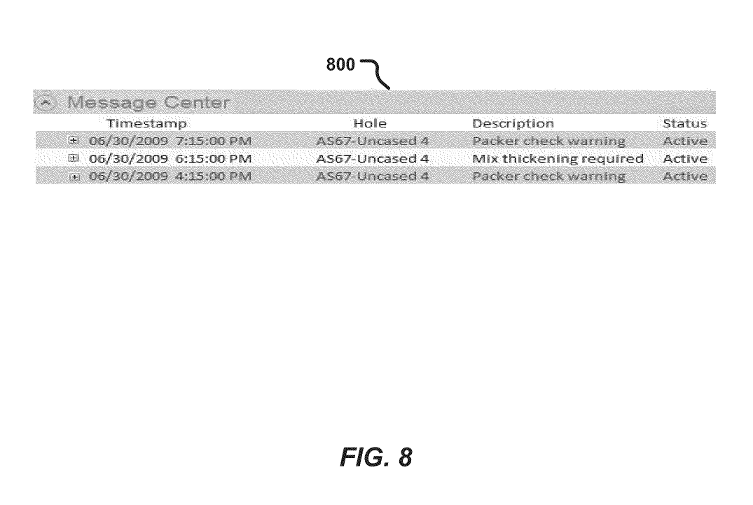

The above table illustrates some of the exemplary verification that may be performed during the verification of the engineering value. Upon verification, a message or alert may be created to inform the operator of the system 100 about deviations, potential problems or suggested courses of action. In certain circumstances, the system 100 may alert the operator to perform a mandatory action. Such alerts may be provided in a convenient message center window such as a message centre module 800 as shown in FIG. 8. The message centre module 800 may also be implemented on the manual-logging device 620, which may be used to issue messages, alerts, guidelines, directives or any other information to the site personnel in possession of the manual-logging device 620.

In another illustrated embodiment, raw data from the plurality of data producers is streamed or transmitted to a remote data repository before processing. The raw data in the data repository is accessible (such as by a customer for specific ground modification project) for quality assurance or other purposes. In other words, the customer can store the raw data in the repository before the data is processed by the present system and method.

### Data Usage by Data Consumers

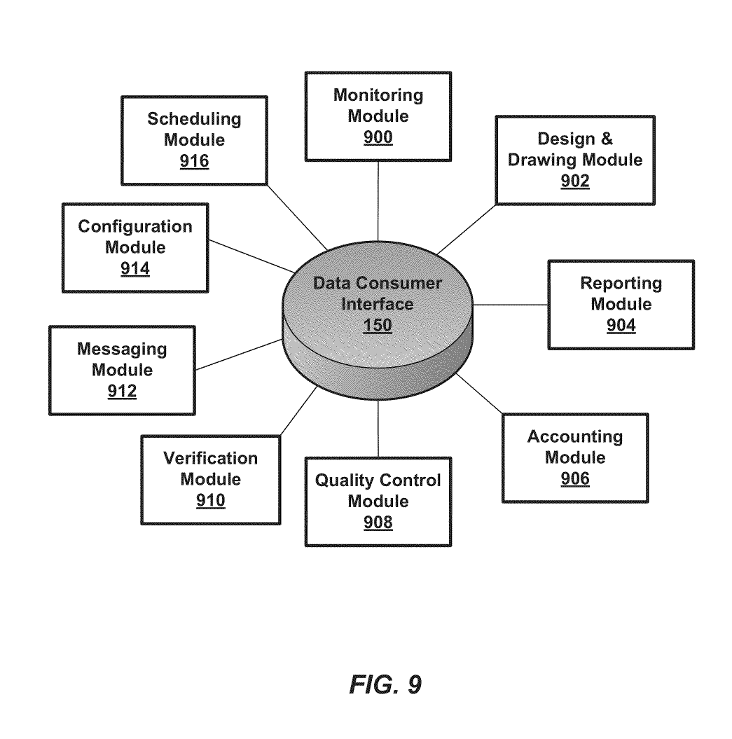

Upon verification of the engineering value, it is made available for consumption by the one or more data consumers. A block diagram representation of some of the data consumers are shown in FIG. 9, accessing the available data through the data consumer interface 150. Access to data may be done using wired or wireless technologies.

In the system 100, there are one or more data consumers. These may include a monitoring module 900, design and drawing module 902, reporting module 904, accounting module 906, quality control module 908, verification module 910, messaging module 912, configuration module 914, and scheduling module 916. While FIG. 9 is shown with modules 900-916, it will be understood that other data consumers may be present. The one or more data consumers are not limited to accessing the engineering value stored in the storage device. There may be other information that may be required by the one or more data consumers. For example, the messaging module 912, configuration module 914 and scheduling module 916 may access non-engineering values, such as status of equipment and configuration/parameter information. An example of the messaging module 912 is the message centre module 800 shown in FIG. 8; an example of the configuration module 914 is the IntelliConsole™ module; and an example of the scheduling module 916 is the project resource planning module 400 in FIG. 400.

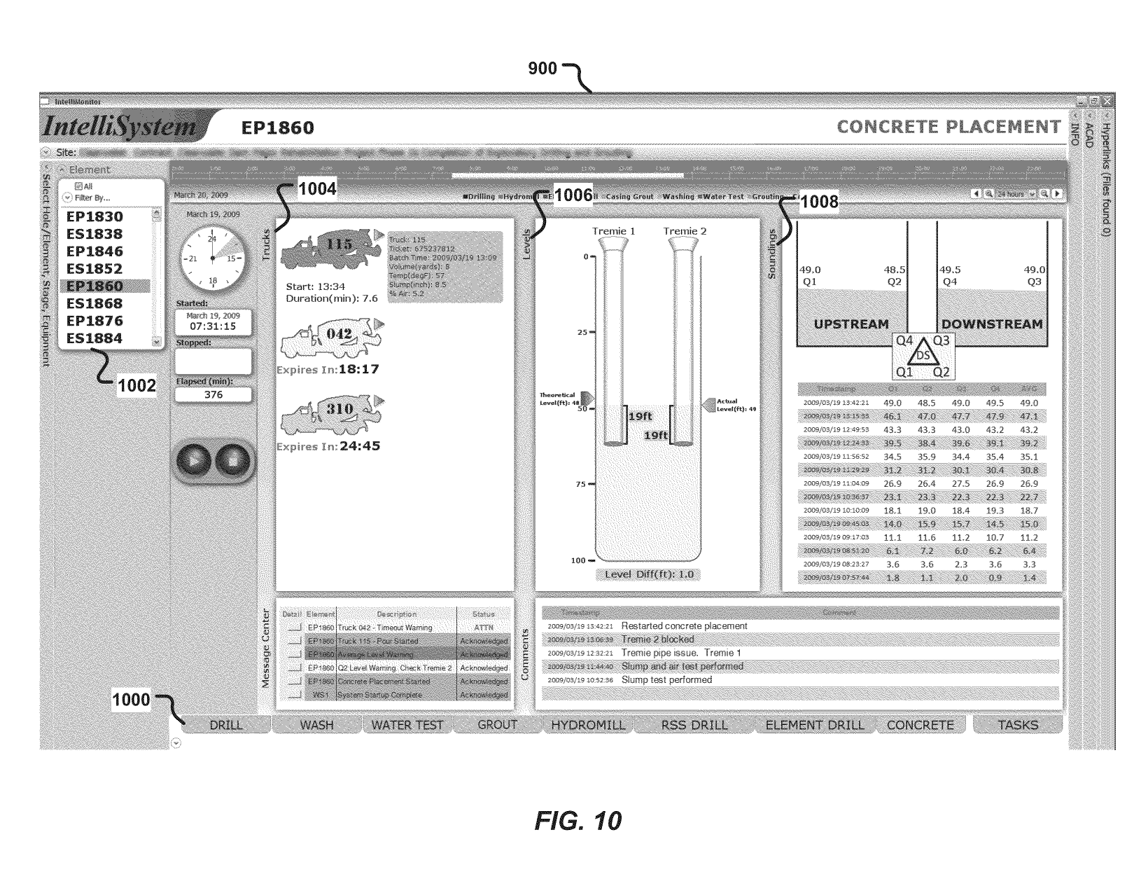

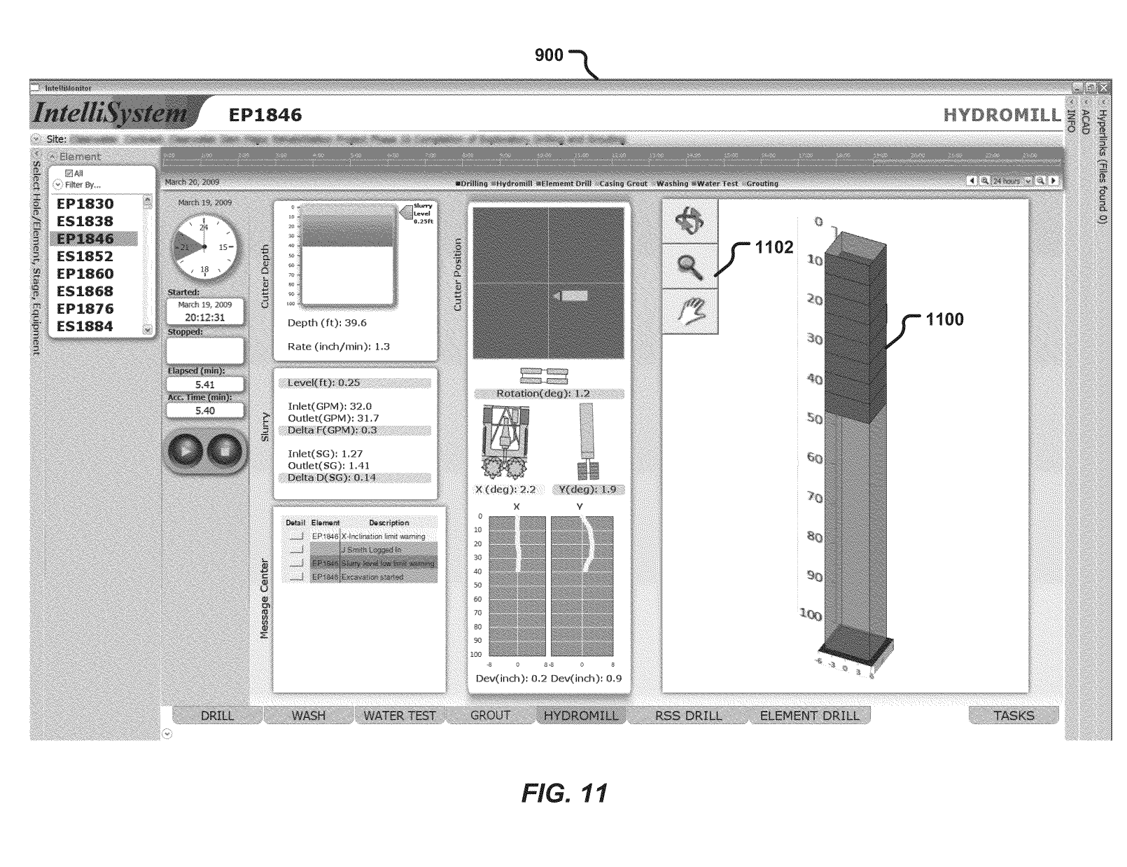

The system 100 further includes a monitoring module 900 (which may also be referred to as IntelliMonitor™ module) for keeping abreast of all the available information in the system 100. For example, the monitoring module 900 may be used to monitor a concrete placement operation as shown in FIG. 10. The monitoring module 900 may include tabs 1000 to easily switch between different ground modification operations. In each tab, information relevant to the ground modification operation may be presented. For example, the monitoring module 900 may allow the operator to filter the information by each element by using the filter 1002. There may also be visual information pertinent to the concrete placement operation, such as information about the cement trucks (i.e. 1004), the concrete levels (i.e. 1006), and soundings (i.e. 1008).

Where appropriate, the monitoring module 900 may also use the design and drawing module 902 (which may also be referred to as InteIIiCADD™ module) to provide a three-dimensional representation of the operation. For example, in FIG. 11, the monitoring module 900 provides a three-dimensional representation 1100 of the excavation operation. A menu 1102 may be provided to interact with the three-dimensional representation 1100, such as rotation, zoom-in and zoom-out, and movement.

Another example of a function of the monitoring module 900 may be the monitoring of scheduled operations and assigned jobs as shown in the task manager module 500 in FIG. 5.

The system 100 may also include a reporting module 904 (which may also be referred to as IntelliReport™ module) for generating reports based on the available data. The generated report may represent a specific point in time in the ground modification operation or may be generated after the successful completion of the operation. Some examples of reports that may be generated include: prescribed daily reports, data grids that amalgamate data from various sources such as a daily drilling summary, trends of pressure test or grouting operations, deviation analysis on drilling, hydromill panel or circular element placement, geologists drill logs, encasement wall excavation reports, barrier wall post-construction reports, calibration reports, list of work to be completed for project planning, and event logs listing all actions and activities that occurred in a given timeframe. The report may be generated manually or automatically by the system as specified in the configuration setting.

The accounting module 906 is a module that records the amount of work completed and materials used. Since the ground modification project may be performed under a contract, the quantities recorded would be helpful in preparing invoices. The module may also allow the operator to adjust the historical quantities in case of discrepancies. It can also act as an audit trail for all the adjustments made and the work performed.

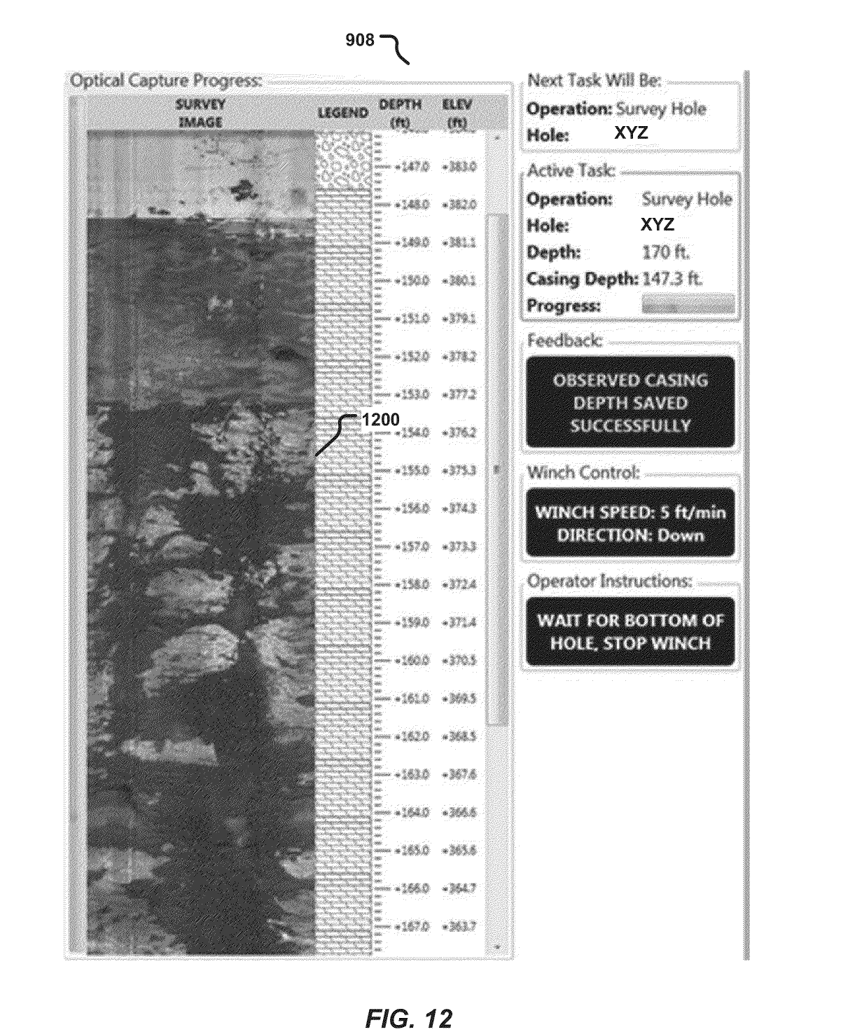

As the ground modification operation progresses, quality of the operation may be checked at different stages of the operation. For example, an RSS drill rig may be used to create an initial hole for the creation of a circular element of a specified diameter and depth. Before performing the next operation to create the circular element, an optical televiewer device may be used to survey the hole. The quality control module 908 in FIG. 12 depicts an exemplary screen for a hole with ID XYZ. In FIG. 12, the survey image 1200 shows a high resolution image of the hole provided by the optical televiewer device. The optical televiewer device may include a 65 mm pan/tilt borehole camera and 44 mm or 90 mm dual-camera with lateral and forward viewing capabilities.

The system of the present disclosure maximizes the value of borehole survey data and improves decision-making capabilities by implementing the following features:
1. Survey information by borehole is produced in a real-time or near real-time fashion.
2. Survey information by borehole is incorporated directly into the system for ready access and for inclusion in context with all other decision support data.

The IntelliCAM device of the present disclosure possesses functionalities including but not limited to:

1. Transfer data from the field wirelessly to IntelliSystem.

2. Send deviation data in near-real-time form the field to the IntelliSystem database to be accessed by and/or incorporated into IntelliSystem applications, particularly the 3D graphical interface and IntelliMonitor module.

3. Streamlined data processing with zero or near-zero manual intervention.

4. View images given a specific depth

5. View survey data given a specific depth

6. Store and access large graphic files using IntelliSystem infrastructure with data integrity obtained as part of IntelliSystem's overall maintenance and backup strategies.

Furthermore, the system 100 may also include a verification module 910 as previously discussed and described, including Table 2. This module provides for the verification of the engineering value based on empirical models configured or rules defined for the specific operation. Moreover, the verification module 910 may also observe for inconsistencies, inefficiencies or anomalies in configurations, scheduling or any other information collected or generated by the system 100.

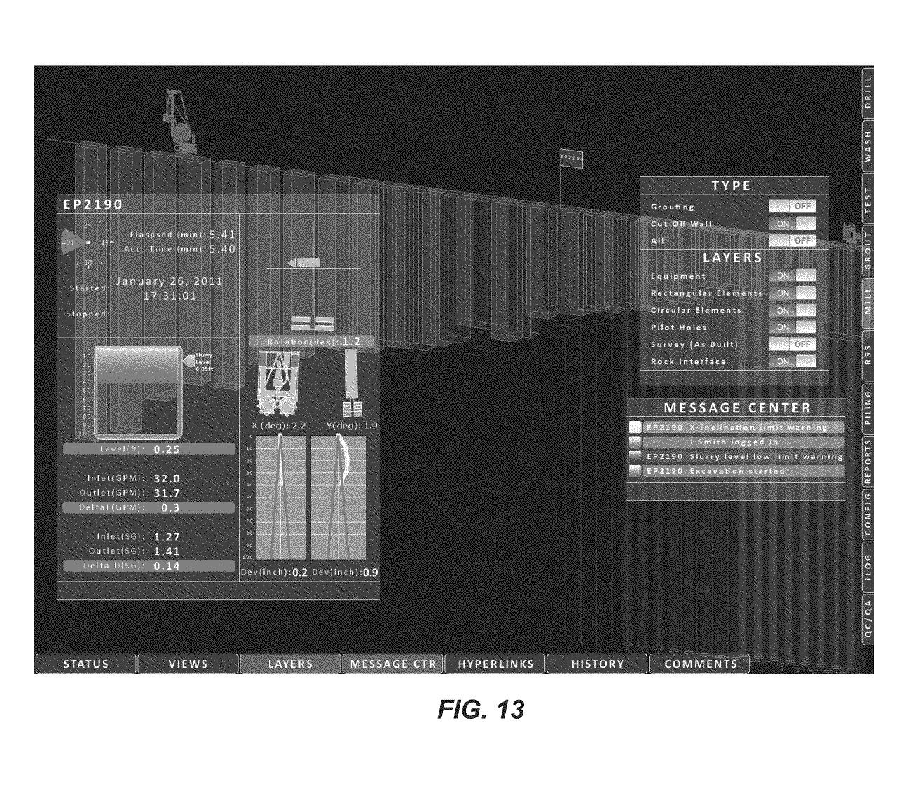

An exemplary embodiment of 3D graphical user interface is shown in FIG. 13. In the system and method of the present disclosure, the 3D graphical user interface provides a real time, interactive operator interface. The additional features of this 3D graphical interface are as follows:
All users navigate to information using a ‘map’ of the project to select objects like holes, hydromill elements, operational equipment and any other project object.
A real-time operational picture is provided through the 3D graphical interface.
Access to historical information is accomplished through this 3D graphical interface.
The IntelliSystem graphical interface uses multiple sources of information (Satellite imagery, existing contours, LIDAR, IntelliSystem database etc).
Geological information such as soil-rock interfaces, voids, fractures and others is displayed in 3D so users have a clear picture of the current underground conditions across the entire extents of the project.
Information from all data producers is tagged with a geolocation so it can be represented on the 3D graphical interface. This includes quality control information and data from the manual data-logging devices 620.
The location of all equipment in operation on the project is displayed on the 3D graphical interface.
Any alarms/alerts are displayed in the 3D graphical interface in two ways. 1.
The alert is seen as text in a dashboard window and 2. As colorized flashing indicator over the hole or equipment that is associated with the data that created the alarm.
Views for the project can be changed at will be the operator using orbit, pan and zoom tools built for the 3D graphical interface.
Dynamic cross sections can be made at any time.
Translucent planes can be projected across the project at any elevation to identify correlations between underground features.
Project information can be tied into the world's coordinate system using GIS functionalities, allowing the system to be used on large projects where work is spread out over large geographical areas.

Essentially, the 3D graphical user interface of the present disclosure is a graphical visualization of all operational information collected in the execution of the project. Additionally, the 3D graphical interface acts as a conduit for users to access this operational information.

Since the 3D graphical user interface provides a representation of all the data collected on the project, one or two data sets would not suffice. Collected data is associated with a geolocation (x,y,z) so it can be represented graphically on the 3D graphical user interface. For instance, a subset of the data collected for a hydromill has the following headings:
Timestamp, x, y, z, SlurryLevel, InletFlow, OutletFlow, InletSG, OutletSG, Rotation, xDev, yDev . . .
While a record for the status of a Grout Cart has following headings:
Timestamp, x,y,z, status, OperationalFL, Operator . . .

While the patent disclosure is described in conjunction with the specific embodiments, it will be understood that it is not intended to limit the patent disclosure to the described embodiments. On the contrary, it is intended to cover alternatives, modifications, and equivalents as may be included within the scope of the patent disclosure as defined by the appended claims. In the description below, numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

It is further understood that the use of relational terms such as first and second, and the like, if any, are used solely to distinguish one from another entity, item, or action without necessarily requiring or implying any actual such relationship or order between such entities, items or actions.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Some portions of the detailed description in the above are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the above discussions, it is appreciated that throughout the specification discussions utilizing terms such as “processing,” “computing,” “calculating,” “determining,” or the like, refer to the action and/or processes of a computer or computing system, or similar electronic computing media player device, that manipulate and/or transform data represented as physical, such as electronic, quantities within the computing system's registers and/or memories into other data similarly represented as physical quantities within the computing system's memories, registers or other such information storage, transmit session or display devices.

Embodiments within the scope of the present disclosure can be implemented in digital electronic circuitry, or in computer hardware, firmware, software, or in combinations thereof. Apparatus within the scope of the present disclosure can be implemented in a computer program product tangibly embodied in a machine-readable storage medium for execution by a programmable processor; and method actions within the scope of the present disclosure can be performed by a programmable processor executing a program of instructions to perform functions of the present disclosure by operating on input data and generating output. Embodiments within the scope of the present disclosure may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files. Embodiments within the scope of the present disclosure include computer-readable media for carrying or having computer-executable instructions, computer-readable instructions, or data structures stored thereon. Such computer-readable media may be any available media, which is accessible by a general-purpose or special-purpose computer system. Examples of computer-readable media may include physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system. Any of the foregoing can be supplemented by, or incorporated in, ASICs (application-specific integrated circuits). It should be understood that embodiments of the present disclosure may be used in a variety of applications. Although the present disclosure is not limited in this respect, the methods disclosed herein may be used in many apparatuses such as in the transmitters, receivers and transceivers of a radio system. Radio systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN), wireless metropolitan area networks (WMAN), wireless wide area networks (WWAN), or wireless personal area networks (WPAN, and the like).

What is claimed is:

1. A system for gathering, analyzing, managing and sharing data from a ground modification project, comprising:
a processor;
a data producer interface coupled to the processor, the data producer interface for interfacing a plurality of data producers, the plurality of data producers being located on-site of the ground modification project and producing data associated with the ground modification project;
a transmitter for sending data produced by the plurality of data producers to a remote data repository accessible for quality control;
a storage device coupled to the processor, the storage device for storing the data produced by the plurality of data producers and received using the data producer interface; and
a data consumer interface coupled to the processor, the data consumer interface for interfacing with one or more data consumers, the data consumer interface providing access to the data stored in the storage device.

2. The system according to claim 1, wherein the plurality of data producers comprise at least one of a data-enabled field equipment and a manual-logging device.

3. The system according to claim 2, wherein the data-enabled field equipment comprises a clamshell excavator, a hydromill, a calipering device, a drilling monitor, a Rotary Steerable System drill, a pressure testing cart, a grouting cart, an optical televiewer, a circular element drill, a core drill, a directional drill, a percussive drill, a pile drill, a survey instrument, a borehole surveyor, a borehole imager, a batch mixing plant, a water plant, or a geotechnical instrument, or any combination thereof.

4. The system according to claim 1, wherein the one or more data consumers comprise a monitoring module, a design and drawing module, a reporting module, an accounting module, a quality control module, a verification module, a messaging module, a configuration module or a scheduling module, or any combination thereof.

5. The system according to claim 1, wherein the storage device further includes at least one of a historian database, an engineering database, and an accounting database.

6. A method for gathering, analyzing, managing and sharing data from a ground modification project, the method executed by a processor comprising:
creating a project plan for the ground modification project, the project plan including a plurality of resources available for the ground modification project;
managing the plurality of resources available for the ground modification project;
receiving data from a plurality of data producers, the plurality of data producers being located on-site of the ground modification project;
transmitting data produced by the plurality of data producers to a remote data repository accessible for quality control;
storing the received data in a storage device;
verifying the received data against a criterion; and
making available to one or more data consumers received data that satisfies the criterion.

7. The method according to claim 6, wherein the method repeats by continuing to receive data from the plurality of data producers.

8. The method according to claim 6, further comprising:
converting the received data to an engineering value; and
storing the engineering value in the storage device.

9. The method according to claim 6, wherein storing the received data in a storage device further comprises:
storing the received data in a historian database.

10. The method according to claim 6, wherein storing the received data in a storage device further comprises:
storing the received data in an engineering database.

11. The method according to claim 10, wherein storing the received data in an engineering database comprises:
categorizing the received data; and
storing the categorized data in a table of the engineering database.

12. The method according to claim 11, wherein categorizing the received data comprises categorizing based on a source of the received data or nature of the received data or both.

13. The method according to claim 6, wherein the criterion comprises an empirical model or a rule or both.

14. The method according to claim 13, wherein verifying the received data against the empirical model comprises:
calculating a result of the empirical model using the received data; and
determining whether the result meets a threshold.

15. The method according to claim 14, further comprising:
generating a message if the result does not meet the threshold.

16. The method according to claim 13, wherein verifying the received data against the rule comprises:
applying the rule against the received data;
determining whether the received data conforms to the rule; and
generating a message if the received data does not conform to the rule.

17. The method according to claim 13, wherein either or both of the empirical model and the rule being configurable in the project plan.

18. The method according claim 6, wherein managing the plurality of resources comprises assigning the plurality of resources available to an operation of the ground modification project.

19. The method according to claim 6, wherein creating a project plan for the ground modification project further comprises verifying the created project plan for an inconsistency, inefficiency or anomaly, or a combination thereof.

20. A computer-readable storage medium comprising instructions in code which when loaded into a memory and executed by a processor of a system causes the system to:
create a project plan for the ground modification project, the project plan including a plurality of resources available for the ground modification project;
manage the plurality of resources available for the ground modification project;
receive data from a plurality of data producers, the plurality of data producers being located on-site of the ground modification project;
transmit data produced by the plurality of data producers to a remote data repository accessible for quality control;
store the received data in a storage device;
verify the received data against a criterion; and
make available to one or more data consumers received data that satisfies the criterion.
